(19) United States
(12) Patent Application Publication
(10) Pub. No.: US 2007/0188788 A1
(43) Pub. Date: Aug. 16, 2007

(54) Method of processing image data and apparatus operable to execute the same

(76) Inventor: Ikuo Hayaishi, Matsumoto-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/707,390

(22) Filed: Feb. 15, 2007

(30) Foreign Application Priority Data
Feb. 16, 2006 (JP) P2006-039299

(51) Int. Cl. H04N 1/60

(52) U.S. Cl. 358/1.9; 358/518

(57) ABSTRACT

It is received first image data described on the basis of a first color space. It is acquired color space converting information adapted to be used to convert the first image data into second image data described on the basis of a prescribed second color space. The first image data is converted into the second image data in accordance with the color space converting information. A feature quantity is extracted from the second image data. A correction table is generated based on the feature quantity so as to include a correspondence between the second image data and third image data. The second data is corrected with reference to the correction table to generate the third image data. The third image data is converted into fourth image data described on the basis of a third color space adapted to be used to generate an image.

### BACKGROUND

1. Technical Field

The present invention relates to a technology for analyzing image data to extract a feature quantity of an image and correcting the image data according to the extracted feature quantity

2. Related Art

With the advance of a digital technology including a computer, images have been mainly handled as digitized image data. When images are represented in a form of image data, the images are received in the computer so as to perform various correction processes on the image data, or the image data is output to a printing apparatus to print the image data. The image data can be generated by using various application programs that are running on the computer. However, in recent years, various image apparatuses, such as a scanner or a digital camera, which generates image data, have been developed and have been in the market.

Further, various technologies have been suggested in which while using a characteristic that images are represented in a form of image date, the image data is analyzed by a computer or the like to extract feature quantities of the images, the image data is corrected according to the extracted feature quantities, and desired images are output. Such technologies are disclosed in, for example, Japanese Patent Publication Nos. 5-63972A (JP-A-5-63972) and 9-233336A (JP-A-9-233336). As feature quantities of the images, various values are used, which include, for example, a smallest grayscale value, a largest grayscale value, an average value of grayscale values, and the like. Since the feature quantities of the images are obtained by analyzing the image data, numerical values of the feature quantities having been obtained becomes numerical values that depend on a color space of the image data.

However, in recent years, in order to generate high-quality image data by sufficiently using performances of various image apparatuses generating the image data, an independent color space that is set according to a characteristic of each of the image apparatuses is generally used for each apparatus. Since the feature quantities of the images are obtained by analyzing the image data, if the image data is described in the independent color space for each apparatus, numerical values of the feature quantities to be obtained become different from one another. As a result, it is difficult to reliably correct the image data.

### SUMMARY

it is therefore one advantageous aspect of the invention to provide a technology for appropriately correcting image data described in different color spaces on the basis of feature quantities of images and generating desired images.

According to one aspect of the invention, there is provided a method of processing image data, comprising:

receiving first image data described on the basis of a first color space;

acquiring color space converting information adapted to be used to convert the first image data into second image data described on the basis of a prescribed second color space;

converting the first image data into the second image data in accordance with the color space converting information;

extracting a feature quantity from the second image data;

generating a correction table based on the feature quantity so as to include a correspondence between the second image data and third image data;

correcting the second data with reference to the correction table to generate the third image data; and

converting the third image data into fourth image data described on the basis of a third color space adapted to be used to generate an image.

The second color space may be a calorimetric color space.

The method may further comprise generating the image based on the fourth image data.

According to one aspect of the invention, there is provided a method of processing image data, comprising:

receiving first image data described on the basis of a first color space;

acquiring color space converting information adapted to be used to convert the first image data into second image data described on the basis of a prescribed second color space;

converting the first image data into the second image data in accordance with the color space converting information;

extracting a feature quantity from the second image data;

correcting the second image data based on the feature quantity to generate third image data;

converting the third image data into fourth image data described on the basis of a third color space adapted to be used to generate an image;

generating a conversion table based on the second image data and the third image data so as to include a correspondence between the first image data and the fourth image data; and

converting the first image data into the fourth image data with reference to the conversion table.

The second color space may be a colorimetric color space.

The method may further comprise generating the image based on the fourth image data.

According to one aspect of the invention, there is provided an apparatus operable to process image data, comprising:

a receiver, operable to receive first image data described on the basis of a first color space;

an acquirer, operable to acquire color space converting information adapted to be used to convert the first image data into second image data described on the basis of a prescribed second color space;

a first converter, operable to convert the first image data into the second image data in accordance with the color space converting information;

an analyzer, operable to extract a feature quantity from the second image data;

a table generator, operable to generate a correction table based on the feature quantity so as to include a correspondence between the second image data and third image data;

a corrector, operable to correct the second data with reference to the correction table to generate the third image data; and

a second converter, operable to convert the third image data into fourth image data described on the basis of a third color space adapted to be used to generate an image.

The second color space may be a calorimetric color space.

The apparatus may further comprise an image generator, operable to generate the image based on the fourth image data.

According to one aspect of the invention, there is provided an apparatus operable to process image data, comprising:

a receiver, operable to receive first image data described on the basis of a first color space;

an acquirer, operable to acquire color space converting information adapted to be used to convert the first image data into second image data described on the basis of a prescribed second color space;

a first converter, operable to convert the first image data into the second image data in accordance with the color space converting information;

an analyzer, operable to extract a feature quantity from the second image data;

a first corrector, operable to correct the second image data based on the feature quantity to generate third image data;

a second converter, operable to convert the third image data into fourth image data described on the basis of a third color space adapted to be used to generate an image;

a table generator, operable to generate a conversion table based on the second data and the third data so as to include a correspondence between the first image data and the fourth image data; and

a third converter, operable to convert the first data with reference to the conversion table to generate the fourth image data.

The second color space may be a calorimetric color space.

The apparatus may further comprise an image generator, operable to generate the image based on the fourth image data.

### BRIEF DESCRIPTION OF THE DRAWINGS

FIG. 1 is a schematic view showing an image generator according to one embodiment of the invention.

FIG. 2 is a perspective view showing an external appearance of the printing apparatus incorporating the image generator.

FIG. 3 is a perspective view showing a state that a table cover of the printing apparatus is opened.

FIG. 4 is a perspective view showing a state that a scanner section of the printing apparatus is lifted up.

FIG. 5 is a schematic view showing an internal configuration of the printing apparatus.

FIG. 6 is a schematic view showing nozzles of printing heads in a printer section of the printing apparatus,

FIG. 7 is a flowchart showing an image print processing executed in the printing apparatus.

FIG. 8 is a diagram for explaining a color conversion table used in a color conversion in the image print processing.

FIG. 9 is a diagram showing a part of a dither matrix used in a halftoning in the image print processing.

FIG. 10 is a diagram showing how to judge whether dots are formed for each pixel with reference to the dither matrix.

FIG. 11 is a flowchart specifically showing an image data correction executed in the image print processing.

FIG. 12 is a diagram for explaining a principle of a correction table generation executed in the image data correction.

FIGS. 13 and 14 are graphs showing examples of a correspondence between L* values of before and after the image data correction.

FIG. 15 is a diagram for explaining the principle of the correction table generation.

FIG. 16 is a diagram for explaining a principle of a correction table generation executed in an image data correction according to a modified example.

### DETAILED DESCRIPTION OF THE EMBODIMENTS

Exemplary embodiments of the invention will be described below in detail with reference to the accompanying drawings.

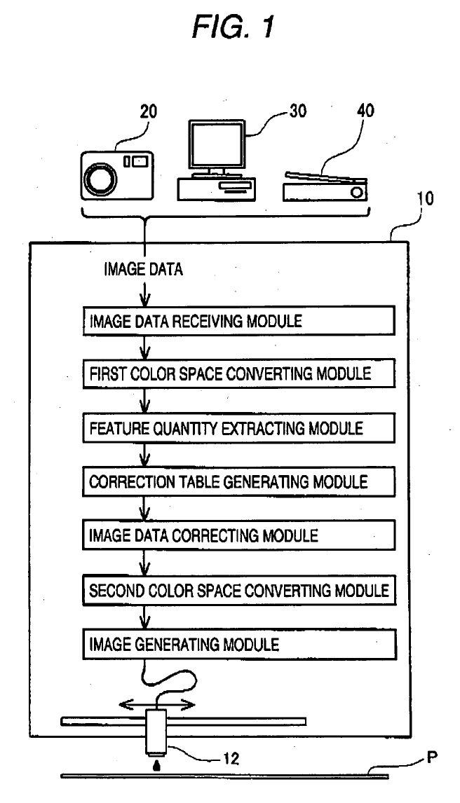

FIG. 1 shows an image generator according to one embodiment of the invention, and exemplifies a printing apparatus 10. When the printing apparatus 10 receives image data from various image apparatuses, such as a digital camera 20, a computer 30, or a scanner 40, and extract feature quantities of an image, the printing apparatus 10 performs an image processing according to the extracted feature quantities, and forms dots on a printing medium P to thus print the image. As such, since the printing apparatus 10 corrects the image data according to the feature quantities and prints the image, the printing apparatus 10 can print a more desirable image.

In recent times, in order to obtain a high-quality image, the image apparatuses, such as the digital camera 20 or the scanner 40, show a tendency to use independent color spaces according to the characteristics of the apparatuses. The feature quantities of the image are obtained by analyzing the image data. Therefore, if image data is represented in an independent color space for each apparatus, numerical values of feature quantities to be obtained are different among the respective apparatuses. As a result, it is difficult to reliably correct the image on the basis of the feature quantities. In order to resolve this problem, as shown in the drawing, the printing apparatus 10 according to this embodiment is provided with various modules that include an “image data receiving module”, a “first color space converting module”, a “feature quantity extracting module”, a “correction table generating module”, an “image data correcting module”, a “second color space converting module”, an “image generating module”, and the like. In this case, the “module” means one that is obtained by classifying a series of processes required for the printing apparatus 10 to print an image according to respective functions. Accordingly, the “module” can be implemented as a portion of a program, implemented by using a logic circuit having a specific function, or implemented by a combination thereof.

When the printing apparatus 10 receives the image data from the image apparatuses, such as the digital camera 20, the computer 30, or the scanner 40, the printing apparatus 10 performs image processings to be described below by using the various modules and prints an image. First, the “image data receiving module” receives the image data from the image apparatuses, such as the digital camera 20, the computer 30, or the scanner 40, and supplies the image data to the “first color space converting module”. At this time, the “image data receiving module” also receives information for a color space where the image data is described, and supplies the image data and the information for the color space to the “first color space converting module”.

The “first color space converting module” converts the color space of the received image data into a standard color space that is previously set for a standard. A color space can be specified from the information for the color space of the image data. When the color space can be specified, it is possible to determine a conversion equation or a conversion matrix for converting the color space into the standard color space. Therefore, the color space for the image data can be converted into the standard color space. Further, a type of the standard color space is not limited so long as it has a sufficient large color gamut and is a color space that is used for a standard. However, if the color space corresponds to a so-called calorimetric color space that is generally represented by an L*a*b* color space, the color space is very advantageous because it has an infinitely large color gamut.

When the “feature quantity extracting module” receives the image data whose color space has been converted into the standard color space by the “first color space converting module”, the “feature quantity extracting module” analyzes the image data and extracts predetermined feature quantities for the image. Next, the “correction table generating module” generates a correction table according to the extracted feature quantities. In this case, the correction table means a numerical table that is referred to when the image data is corrected. The data before correction and the data after correction are stored in the correction table in a state where the data before the correction and the data after correction are associated with each other. In order that proper correction is performed according to the feature quantities, the “correction table generating module” generates the correction table, as described later.

The “image data correcting module”, corrects the image data of the standard color space while referring to the correction table generated in the above-described manner, and supplies the image data after correction to the “second color space converting module”. The “second color space converting module” converts the color space of the received image data into a color space for generating the image (color space for output), and supplies it to the “Image generating module”. The “image generating module” drives an ink ejecting head 12 on the basis of the image data obtained in the above-described manner, and forms the ink dots on the printing medium P to thus print the image.

As described above, the printing apparatus 10 shown in FIG. 1 converts the color space of the image data received from the image apparatuses, such as the digital camera 20 or the scanner 40, into the standard color space, and extracts the feature quantities of the image in the standard color space. In addition, the printing apparatus 10 corrects the image data by using the correction table generated on the basis of the feature quantities having been extracted, and outputs the image. For this reason, the correction of the image data can be performed in the standard color space. Therefore, the received image data can be reliably corrected regardless of the difference between the color spaces and thus a desired image can be output. Hereinafter, the printing apparatus 10 having the above-described structure will be described in detail on the basis of the embodiments.

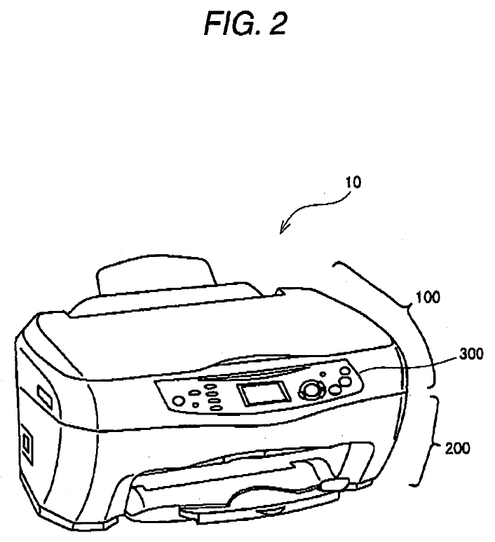

As shown in FIG. 2, the printing apparatus 10 of this embodiment includes a scanner section 100, a printer section 200, and a control panel 300 that controls operations of the scanner section 100 and the printer section 200. The scanner section 100 has a scanner function of reading a printed image and generating image data. The printer section 200 has a printer function of receiving the image data and printing an image on a printing medium. Further, if an image (original image) read by the scanner section 100 is output from the printer section 200, a copier function can be realized. That is, the printing apparatus 10 of this embodiment is a so-called scanner/printer/copier hybrid apparatus (hereinafter, referred to as SPC hybrid apparatus) that can solely realize the scanner function, the printer function, and the copier function.

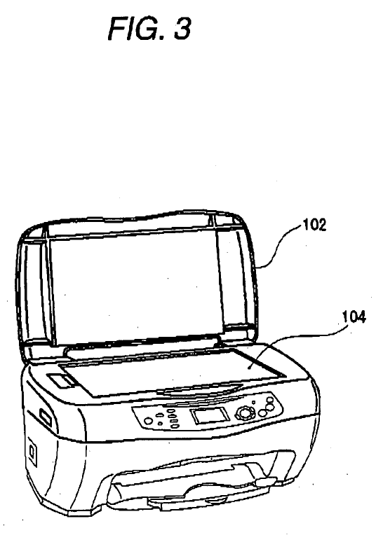

As shown in FIG. 3, when a table cover 102 is opened upward, a transparent original table 104 is provided, and various mechanisms, which will be described below, for implementing the scanner function are mounted therein. When an original image is read, the table cover 102 is opened, and the original image is placed on the original table 104. Net, the table cover 102 is closed, and a button on the control panel 300 is operated. Then, the original image can be directly converted into image data.

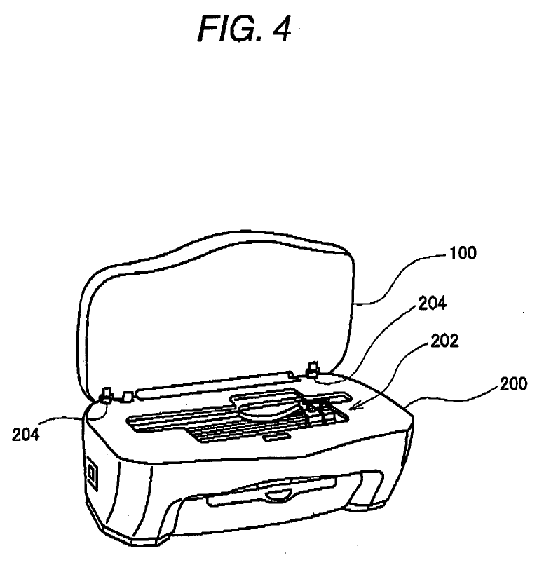

Further, the entire scanner section 100 is housed in a case as a single body, and the scanner section 100 and the printer section 200 are coupled to each other by a hinge mechanism 204 (see FIG. 4) on a rear side of the printing apparatus 10. For this reason, only the scanner section 100 can rotate around the hinge when a front side of the scanner section 100 is lifted.

As shown in FIG. 4, in the printing apparatus 10 of this embodiment, when the front side of the scanner section 100 is lifted, the top face of the printer section 200 can be exposed. In the printer section 200, various mechanisms, which will be described below, for implementing the printer function, are provided. Further, in the printer section 200, a control circuit 260, which will be described below, for controlling the overall operation of the printing apparatus 10 including the scanner section 100, and a power supply circuit (not shown) for supplying power to the scanner section 100 or the printer section 200 are provided. In addition, as shown in FIG. 4, an opening portion 202 is provided on the upper face of the printer section 200, through which replacement of consumables such as ink cartridges, treatment of paper jam, and easy repair can be simply executed.

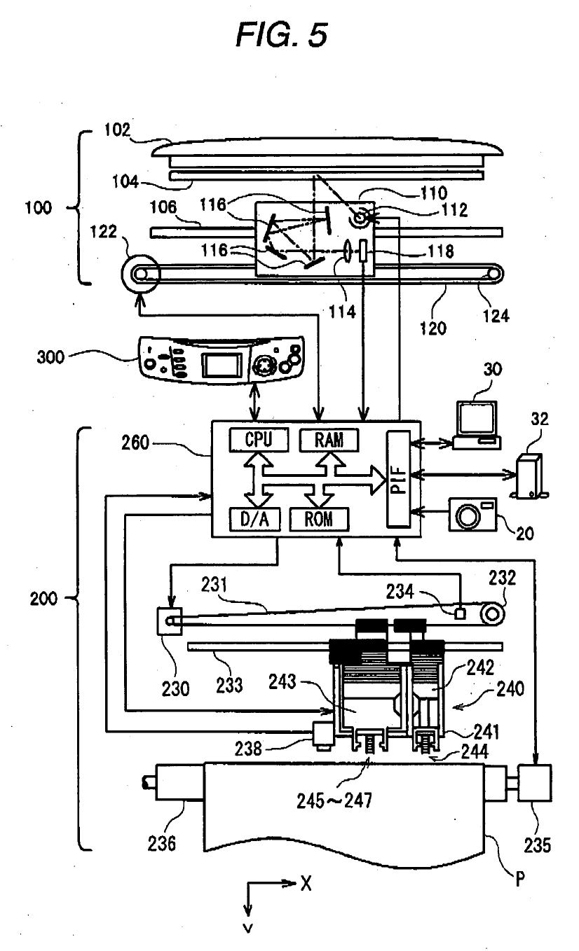

Next, a description is given of the internal constructions of the scanner section 100 and the printer section 200 with reference to FIG. 5.

The scanner section 100 includes: the transparent original table 104 on which a printed original color image is set; a table cover 102 which presses a set original color image; a scanner carriage 110 for reading an original color image; a carriage belt 120 to move the scanner carriage 110 in the primary scanning direction X; a drive motor 122 to supply power to the carriage belt 120; and a guide shaft 106 to guide movements of the scanner carriage 110. In addition, operations of the drive motor 122 and the scanner carriage 110 are controlled by the control circuit 260 described later.

The scanner section 100 includes a transparent original table 104, on which a original image is set, a table cover 102 that presses the set original image, a reading carriage 110 that reads the set original image, a driving belt 120 that moves the reading carriage 110 in a reading direction (main scanning direction), a driving motor 122 that supplies power to the driving belt 120, and a guide shaft 106 that guides the movement of the reading carriage 110. Further, the operation of the driving motor 122 or the reading carriage 110 is controlled by a control circuit 260 described below.

As the drive motor 122 is rotated under control of the control circuit 260, the motion thereof is transmitted to the scanner carriage 110 via the carriage belt 120. As a result, the scanner carriage 110 is moved in the primary scanning direction X in response to the turning angle of the drive motor 122 while being guided by the guide shaft 106, Also, the carriage belt 120 is adjusted in a state that proper tension is always given thereto by an idler pulley 124. Therefore, it becomes possible to move the scanner carriage 110 in the reverse direction by the distance responsive to the turning angle if the drive motor 122 is reversely rotated.

A light source 112, a lens 114, mirrors 116, and a CCD sensor 118 are incorporated in the interior of the scanner carriage 110. Light from the light source 112 is irradiated onto the original table 104 and is reflected from an original color image set on the original table 104. The reflected light is guided to the lens 114 by the mirror 116, is condensed by the lens 114 and is detected by the CCD sensor 118. The CCD 118 is composed of a linear sensor in which photo diodes for converting the light intensity to electric signals are arrayed in the direction orthogonal to the primary scanning direction X of the scanner carriage 110. For this reason, while moving the scanner carriage 110 in the primary scanning direction X, light of the light source 112 is irradiated onto an original color image, and the intensity of the reflected light is detected by the CCD sensor 118, whereby it is possible to obtain electric signals corresponding to the original color image.

Further, the light source 112 is composed of light emitting diodes of three colors of RGB, which is able to irradiate light of R color, G color and B color at a predetermined cycle by turns. In response thereto, reflected light of R color, G color and B color can be detected by the CCD sensor 118 by turns. Generally, although red portions of the image reflect light of R color, light of G color and B color is hardly reflected. Therefore, the reflected light of R color expresses the R component of the image. Similarly, the reflected light of G color expresses the G component of the image, and the reflected light of B color expresses the B component of the image. Accordingly, light of three colors of RGB is irradiated onto an original color image while being changed at a predetermined cycle. If the intensities of the reflected light are detected by the CCD sensor 118 in synchronization therewith, it is possible to detect the R component, G component, and B component of the original color image, wherein the color image can be read addition, since the scanner carnage 110 is moving while the light source 112 is changing the colors of light to be irradiated, strictly speaking, the position of an image for which the respective components of RGB are detected will differ corresponding to the amount of movement of the scanner carriage 110. However, the difference can be corrected by an image processing after the respective components are read.

The printer section 200 is provided with the control circuit 260 for controlling the operations of the entirety of the printing apparatus 10, a printer carriage 240 for printing images on a printing medium P, a mechanism for moving the printer carriage 240 in the primary scanning direction X, and a mechanism for feeding the printing medium P.

The printer carriage 240 is composed of an ink cartridge 242 for accommodating K ink, an ink cartridge 243 for accommodating various types of ink of C ink, M ink, and Y ink, and a head unit 241 secured on the bottom face. The head unit 241 is provided with an head for ejecting ink droplets per ink. If the ink cartridges 242 and 243 are mounted in the printer carriage 240, respective ink in the cartridges are supplied to the printing heads 244 through 247 of respective ink through a conduit (not illustrated).

The mechanism for moving the printer carriage 240 in the primary scanning direction X is composed of a carriage belt 231 for driving the printer carriage 240, a carriage motor 230 for supplying power to the carriage belt 231, a tension pulley 232 for applying proper tension to the carriage belt 231 at all times, a carriage guide 233 for guiding movements of the printer carriage 240, and a reference position sensor 234 for detecting the reference position of the printer carriage 240. If the carriage motor 230 is rotated under control of a control circuit 260 described later, the printer carriage 240 can be moved in the primary scanning direction X by the distance responsive to the turning angle. Further, if the carriage motor 230 is reversed, it is possible to cause the printer carriage 240 to move in the reverse direction.

The mechanism for feeding a printing medium P is composed of a platen 236 for supporting the printing medium P from the backside and a medium feeding motor 235 for feeding paper by rotating the platen 236. If the medium feeding motor 235 is rotated under control of a control circuit 260 described later, it is possible to feed the printing medium P in a secondary scanning direction Y by the distance responsive to the turning angle.

The control circuit 260 is composed of a ROM, a RAM, a D/A converter for converting digital data to analog signals, and further an interface PIF for peripheral devices for communications of data between the CPU and the peripheral devices, including the CPU. The control circuit 260 controls operations of the entirety of the printing apparatus 10 and controls these operations through communications of data between the light source 112, the drive motor 122 and the CCD 118, which are incorporated in the scanner section 100. Further, the control circuit 260 performs a processing for analyzing image data so as to extract a feature quantity, and a processing for correcting the image data corresponding to the feature quantity.

In addition, the control circuit 260 controls supplying drive signals to the printing heads 244 through 247 of respective colors and ejecting ink droplets while causing the printer carriage 240 to be subjected to primary scanning and secondary scanning by driving the carriage motor 230 and the medium feeding motor 235, in order to form an image on a printing medium P. The drive signals supplied to the printing heads 244 through 247 are generated by reading image data from a computer 30 and a digital camera 20, and executing an image processing described later. As a matter of course, by applying an image processing to the RGB image data read by the scanner section 100, it is possible to generate the drive signals. Thus, under the control of the control circuit 260, ink dots of respective colors are formed on a printing medium P by ejecting ink droplets from the printing heads 244 through 247 while causing the printer carriage 240 to be subjected to the primary scanning and secondary scanning, whereby it becomes possible to print a color image. As a matter of course, instead of executing an image processing for forming the image in the control circuit 260, it is possible to drive the printing heads 244 through 247 by receiving data, which has been subjected to image processing in advance, from the computer 30 while causing the printer carriage 240 to be subjected to the primary scanning and secondary scanning in compliance with the data.

Also, the control circuit 260 is connected so as to receive data from and transmit the same to the control panel 300, wherein by operating respective types of buttons secured on the control panel 300, it is possible to set detailed operation modes of the scanner function and the printer function. Furthermore, it is also possible to set detailed operation modes from the computer via the interface PIF for peripheral devices.

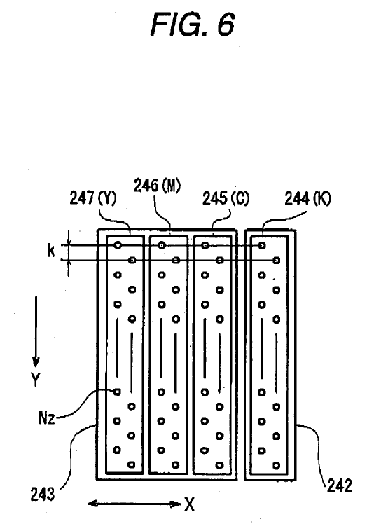

As shown in FIG. 6, a plurality of nozzles Nz for ejecting ink droplets are formed on the printing heads 244 through 247 of respective colors. As shown, four sets of nozzle arrays which eject ink droplets of respective colors are formed on the bottom face of the printing heads of respective colors. In one set of the nozzle arrays, 48 nozzles Nz are arrayed in a zigzag manner with a pitch K Drive signals are supplied from the control circuit 260 to the respective nozzles Nz, and the respective nozzles Nz eject drops of respective ink in compliance with the drive signals.

There may be adopted various ways for ejecting the ink droplets from the ink ejection head. For example, a piezoelectric element may be used so as to eject ink, and a heater may be provided at an ink passage and generating bubbles in the ink passage so as to eject ink. Further, a phenomenon such as thermal transfer or the like may be utilized so as to form an ink dot on a printing paper, and a static electricity may be utilized so as to adhere toner powders in each color on a printing medium.

The above-described printing apparatus 10 receives the image data from the digital camera 20 or the like or image data obtained by reading a document image by the scanner unit 100, the printing apparatus 10 extracts a feature quantity of an image in the control circuit 260, and corrects the image data according to the extracted feature quantity to thus print a desired image. The color space of the image data may be different according to a type of an apparatus (digital camera 20 or the like) having generated the image data. When the color space is different, a value of the extracted feature quantity may be different. Therefore, it is difficult to reliably correct the image data. In view of this point, the printing apparatus 10 according to this embodiment can perform a proper correction processing regardless of the color space of the image data, the printing apparatus 10 prints the image as follows. Hereinafter, a processing (image print processing) will be described in which the printing apparatus 10 receives the image data and prints the image.

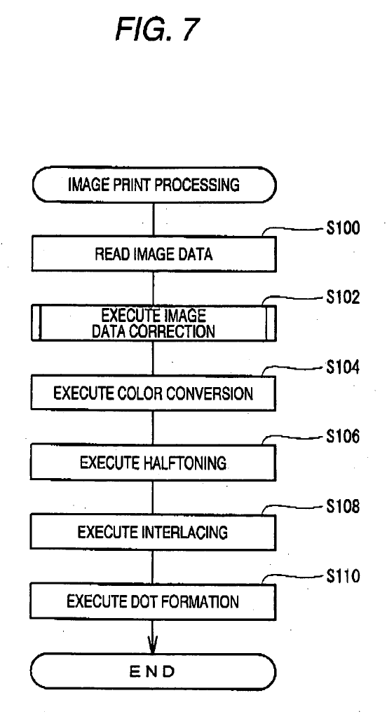

FIG. 7 shows the image print processing that is performed by the printing apparatus 10 in order to print an image. This processing is performed by the control circuit 260 mounted on the printing apparatus 10 using the internal CPU, RAM, or ROM. Hereinafter, the description will be given on the basis of the flowchart.

When an image is printed, a processing for reading image data of an image to be printed is performed at first (step S100). As the image data, image data corresponding to an image captured by the digital camera 20, image data created by various application programs working on the computer 30, and image data corresponding to an image scanned by the scanner section 100 can be used. Further, in this embodiment, each of these image data is RGB image data expressed by a grayscale value in each color of R, G and B. However, RGB image data has various specifications of a color space such as an sRGB color space. Accordingly, when the image data is read out, in addition to the RGB image data, information indicating a color space where the RGB image data is described is also obtained.

Then, after the printing apparatus 10 analyzes the image data so as to extract the feature quantity of the image, the printing apparatus 10 performs a processing for correcting the image data according to the extracted feature quantity (step S102). According to this image data correction, the color space of the received image data is converted into a colorimetric color space (in this case, L*a*b* color space) so as to extract the feature quantity, and the correction table is generated on the basis of the extracted feature quantities so as to perform a proper correction processing regardless of the color space of the image data. In the image data correction according to this embodiment, the color space of the image data is converted into the calorimetric color space. However, the color space is not limited to the calorimetric color space. That is, a type of the color space is not limited so long as it has a sufficiently large color gamut and is widely used for a standard. The image data correction will be described in detail later.

When the image data is corrected according to the feature quantity, the control circuit 260 performs a color conversion on the obtained image data (step S104). The color conversion is a processing that converts image data into image data (CMYK image data) represented by grayscale values of respective colors including C (cyan), M (magenta), Y (yellow), and K (black). In this embodiment, since the image data having been corrected by the image data correction is supplied so as to be subjected to a color conversion in a state where the image data is converted into the RGB image data, the color conversion performs a processing that converts the RGB image data into the CMYK image data. The color conversion is performed by referring to a three-dimensional numerical table that is referred to as a color conversion table (LUT). When the image data having been corrected by the image data correction is supplied as the image data of the calorimetric color space to be subjected to the color conversion, the color conversion performs a processing that converts the image data represented by an L*a*b* colorimetric value into the CMYK image data.

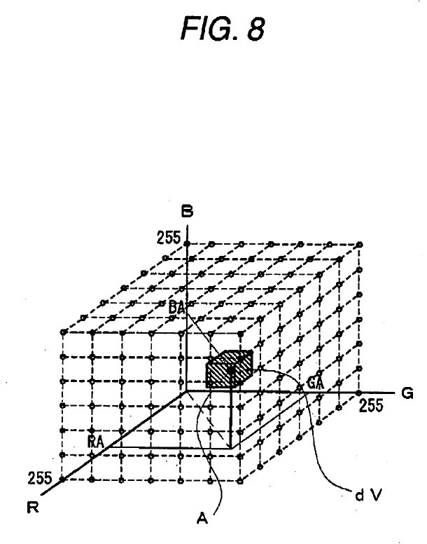

Now, an RGB color space is taken into account, in which grayscale values of respective colors of R, G and B are taken in three axes orthogonal to each other as shown in FIG. 8, and it is assumed that the grayscale values of respective colors of RGB take values from 0 through 255. If so, all the RGB image data can be associated with an internal point of a cube (color solid), the original point of which is the top and the length of one side of which is 255. Therefore, changing the view point, if a plurality of lattice points are generated in the RGB color space by fragmenting the color solid in the form of a lattice orthogonal to the respective axes of RGB, it is considered that respective lattice points correspond to the RGB image data respectively. Therefore, combinations of grayscale values corresponding to the use amounts of ink of respective colors of C, M, Y and K are stored in advance in the respective lattice points. Thereby, the RGB image data can be quickly converted to image data corresponding to the use amounts of respective colors of ink (CMYK image data) by reading the grayscale values stored in the lattice points.

For example, if it is assumed that the R component of the image data is RA, the G component thereof is GA and the B component thereof is BA, the image data are associated with the point A in the RGB color space. Therefore, a cube dV having the point A included therein is detected from minute cubes which is fragmented from the color solid, the grayscale values of respective colors of ink, which are stored in the respective lattice points of the cube dV, are read. And, it is possible to obtain the grayscale value of the point A by executing an interpolation calculation based on the grayscale values the respective lattice points. As described above, it can be considered that the look-up table (LUT) is a three-dimensional numerical table in which combinations of grayscale values corresponding to the use amounts of ink of respective colors of C, M, Y and K are stored in a plurality of lattice points established in the RGB color space. And, by referencing the look-up table, it is possible to quickly convert the RGB image data in terms of color.

After the color conversion is terminated as described above, a halftoning is executed in the image copy processing shown in FIG. 7 (Step S106). The gradation data corresponding to the use amounts of ink of respective colors of CMYK obtained by the color conversion are data which can take a value from the grayscale value 0 through the grayscale value 255 per pixel. To the contrary, in the printer section 200, the printer section takes only a status on whether or not a dot is formed, with attention directed to individual pixels since the printer section 200 prints an image by forming dots. Therefore, it is necessary to convert the CMYK gradation data having 256 gradations to data (dot data) showing whether or not a dot is formed per pixel. The halftoning is a processing for converting the CMYK gradation data to dot data.

As a method for executing the halftoning, various types of methods such as an error diffusion method and a dither method may be employed. The error diffusion method diffuses the error in gradation expression generated in a certain pixel, by judging whether or not dots are formed in regard to the pixel, to the peripheral pixels, and at the same time, judges whether or not dots are formed in regard to respective pixels, so that the error diffused from the periphery can be dissolved. Also, the dither method compares the threshold values set at random in a dither matrix with the CMYK gradation data per pixel, and, for pixels in which the CMYK gradation data are greater, judges that dots are formed, and for pixels in which the threshold value is greater, judges that no dot is formed, thereby obtaining dot data for the respective pixels.

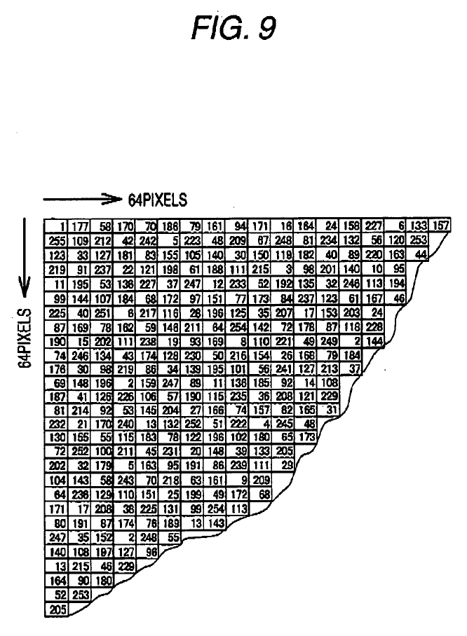

FIG. 9 shows a part of the dither matrix. In the illustrated matrix, threshold values universally selected from the range of the grayscale values 0 through 255 are stored at random in 4096 pixels consisting of 64 pixels disposed in both the vertical and horizontal directions. Herein, the reason why the grayscale values of the threshold values are selected in the range of 0 through 255 corresponds to that the CMYK image data is of 1 byte in the embodiment, and the grayscale value takes a value from 0 through 255. In addition, the size of the dither matrix is not limited to 64 pixels in both the vertical and horizontal directions as shown in FIG. 9, but may be set to various sizes including a case in which the number of pixels differs in the vertical and horizontal directions.

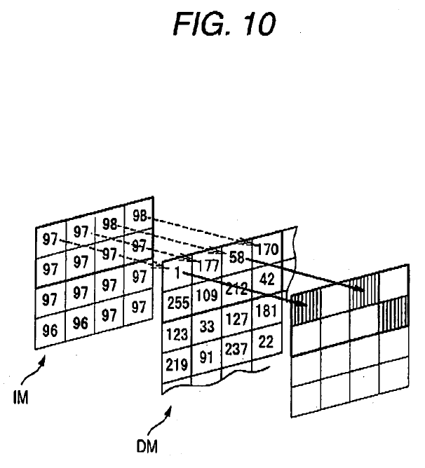

FIG. 10 shows how to judge whether or not dots are formed per pixel with reference to the dither matrix. Such judgment is made for respective colors of CMYK. However, hereinafter, to avoid complicated description, the CMYK image data are handled merely as image data without distinguishing respective colors of the CMYK image data.

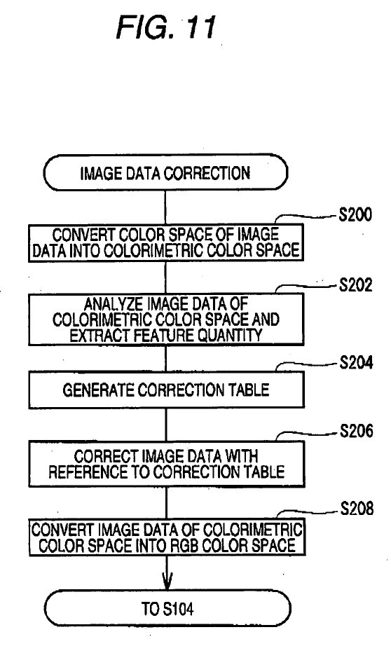

When judging whether or not dots are formed, first, the grayscale value of the image data IM for a pixel to which attention is focused as an object to be judged (pixel of interest) is compared with the threshold value stored in the corresponding position in the dither matrix DM. The arrow of a dashed line, which is shown in the drawing, schematically expresses that the image data of the noted pixel are compared with the threshold value stored in the corresponding position in the dither matrix. Where the image data of the noted image is greater than the threshold value of the dither matrix, it is judged that a dot is formed for the pixel. To the contrary, where the threshold value of the dither matrix is greater than the other, it is judged that no dot is formed for the pixel. In the example shown in FIG. 10, the image data of the pixel located at the left upper corner of the image is “97”, and the threshold value stored in the position corresponding to the pixel in the dither matrix is “1”. Therefore, since, on the pixel located at the left upper corner, the image data are greater than the threshold value of the dither matrix, it is judged that a dot is formed for the pixel. The arrow of a solid line shown in the FIG. 11 schematically expresses the state that the result of judgment is written in a memory upon judging that a dot is formed.

On the other hand, in regard to a pixel adjacent to this pixel at the right side, the image data are “97”, and the threshold value of the dither matrix is “177”, wherein the threshold value is greater than the other. Therefore, it is judged that no dot is formed. Thus, by comparing the image data with the threshold value set in the dither matrix, It is possible to determine, at respective pixels, whether or not dots are formed. In the halftoning (Step S106 in FIG. 7), the above-described dither method is applied to the gradation data corresponding to the use amounts of respective ink of C, M, Y and K, whereby the processing of generating dot data is executed while judging, for each of the pixels, whether or not dots are formed.

After the gradation data of the respective colors of CMYK are converted to dot data, an interlacing is executed (Step S108). The interlacing re-arranges the dot data in the order along which the head unit 241 forms dots, and supplies the data to the printing heads 244 through 247 of the respective colors. That is, as shown in FIG. 6, since the nozzles Nz secured at the printing heads 244 through 247 are provided in the secondary scanning direction Y with the interval of nozzle pitch k spaced from each other, if ink drops are ejected while causing the printer carriage 240 to be subjected to primary scanning, dots are formed with the interval of nozzle pitch k spaced from each other in the secondary scanning direction Y. Therefore, in order to form dots in all the pixels, it is necessary that the relative position between the head 240 and a printing medium P is moved in the secondary scanning direction Y, and new dots are formed at pixels between the dots spaced only by the nozzle pitch k As has been made clear from this, when actually printing an image, dots are not formed in the order from the pixels located upward on the image. Further, in regard to the pixels located in the same row in the primary scanning direction X, dots are not formed by one time of primary scanning, but dots are formed through a plurality of times of primary scanning based on the demand of the image quality, wherein it is widely executed that dots are formed at pixels in skipped positions in respective times of primary scanning.

Thus, in a case of actually printing an image, since it does not mean that dots are formed in the order of arrangement of pixels on the image, before actually commencing formation of dots, it becomes necessary that the dot data obtained for each of the colors of C, M, Y and K are rearranged in the order along which the printing heads 244 through 247 form the same. Such a processing is called an “interlacing.”

After the interlacing is completed, a processing of actually forming dots on a printing medium P (dot formation) is executed by the control circuit 260 based on the data obtained by the interlacing (Step S10). That is, while causing the printer carriage 240 to be subjected to primary scanning by driving the carriage motor 230, the dot data (printing control data) whose order has been rearranged are supplied to the printing heads 244 through 247. As a result, the ink droplets are ejected from the ink ejection heads 244 through 247 according to the dot data indicative of whether a dot is formed in each pixel, so that the dots are appropriately formed at each pixel.

After one time of primary scanning is completed, the printing medium P is fed in the secondary scanning direction Y by driving the medium feeding motor 235. After that, again, the dot data (printing control data) whose order has been rearranged are supplied to the printing heads 244 through 247 to form dots while causing the printer carriage 240 to be subjected to primary scanning by driving the carriage motor 230, By repeating such operations, dots of respective colors of C, M, Y and K are formed on the printing medium P at a proper distribution responsive to the grayscale values of the image data. As a result, the image is printed.

Further, as described above, in the image print processing, the image data is corrected according to the feature quantity, ink dots are formed on the printing medium with a proper density on the basis of the obtained image data. Further, when the image data is corrected, in consideration of the point that the image data is described in various color spaces, the feature quantity of the image is extracted from the colorimetric color space, the correction table according to the extracted feature quantity is generated, and the image data is corrected. For this reason, it is possible to appropriately and quickly correct the image data regardless of the color space where the image data is described. Hereinafter, a processing for correcting image data (image data correction) executed in the image print processing will be described in detail with reference to FIG. 11.

This processing is performed with respect to the RGB image data when the printing apparatus receives the RGB image data to be printed and information for a color space where the image data is described.

When the image data correction starts, first, a processing is performed for converting the color space of the received image data into the colorimetric color space (in this case, L*a*b* calorimetric color space) (step S200). In this case, since the information for the color space where the image data is described is obtained in advance, it is possible to easily perform the processing for converting the color space into the calorimetric color space. Further, in this embodiment, the RGB image data is converted into the image data of the colorimetric color space. However, if the corresponding color space has a sufficiently large color gamut and corresponds to a color space used for a standard, the image data may be converted into image data of an arbitrary color space, instead of the calorimetric color space.

Next, predetermined feature quantities are extracted from the image data by analyzing the image data converted into the calorimetric color space (step S202). As extracted feature quantities, various known feature quantities can be extracted. For example, it is possible to extract a smallest grayscale value and a largest grayscale value in the image data, an average value of grayscale values, the standard deviation of the grayscale values, a histogram of the grayscale values, and the like.

When the feature quantity is extracted from the image data in the calorimetric color space, a processing for generating a correction table according to the extracted feature quantities starts (step S204). The correction table is a numerical table in which a grayscale value of the image data before correction and a grayscale value of the image data after correction are associated with each other. When the correction table is generated, it is possible to quickly correct the image data by referring to the correction table. The correction table according to the feature quantity can be generated as follows.

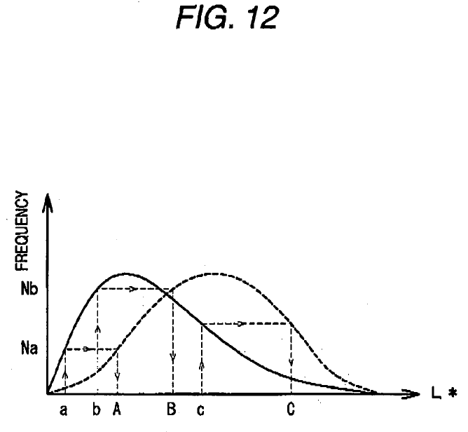

FIG. 12 conceptually shows a principle of generating a correction table according to a histogram of a brightness value L* that is extracted from image data. For example, if the brightness value L* of arbitrary image data is analyzed, a histogram is obtained, as shown by a solid line in FIG. 12. Since the histogram is in a state that the brightness of the image is biased at a side where the brightness is small (dark side), a reproducible range of brightness is not sufficiently used. Therefore, it is considered that the histogram is converted into an ideal histogram to be set in advance. In FIG. 12, a histogram of the ideal brightness value L* to be set in advance is shown by a dashed line.

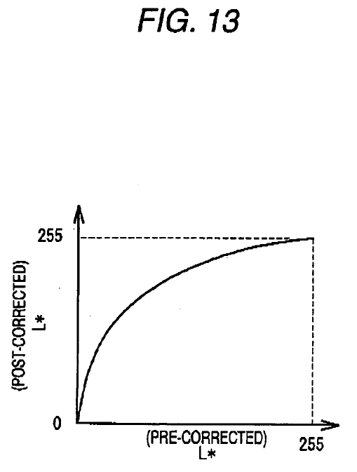

For example, according to the histogram that is obtained by an analysis and is shown by a solid line, a frequency of the L* value “a” becomes Na. Meanwhile, according to the ideal histogram that is shown by a dashed line, the L* value of the frequency Na becomes a value “A”. Accordingly, the L* value “a” of the image data is corrected to the L* value “A”. Similarly, according to the histogram that is obtained by an analysis and is shown by a solid line, a frequency of the L* value “b” becomes Nb. Meanwhile, according to the ideal histogram that is shown by a dashed line, the L* value of the frequency Nb becomes a value “B”. Accordingly, the L* value “b” of the image data is corrected to the L* value “B”. In this way, if the L* values after correction are associated with all of the L* values, it is possible to generate a correction table in which the histogram of the L* value is corrected to the ideal histogram. FIG. 13 shows a correspondence between the L* values before correction and the L* values after correction that are obtained in the above-described processing. The correction table is generated on the basis of the correspondence.

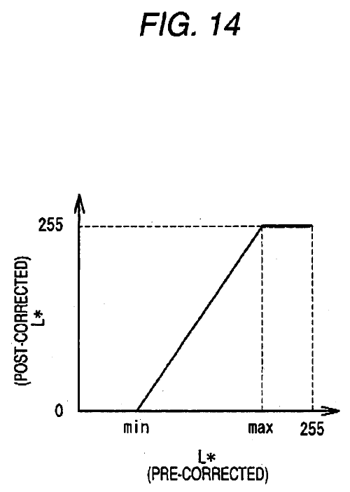

FIG. 14 shows another example of a correspondence between data before correction and data after correction that are generated according to a range of grayscale values of L* values that are extracted from image data. For example, it is assumed that a smallest brightness value is “min” and a largest brightness value is “max”, as a result that is obtained by analyzing a brightness value L* of arbitrary image data. That is, in such an image, only a brightness range from “min” to “max” is used, and a reproducible range of brightness is not sufficiently used. In such a case, the image data is corrected in accordance with the correspondence exemplified in FIG. 14. Specifically, the smallest brightness value “min” in the image is converted into a brightness value “0” and the largest brightness value “max” in the image is converted into a brightness value “255”. As a result, it is possible to sufficiently use a reproducible range of brightness. In FIG. 14, it is exemplified the case where a range of grayscale values in the image is converted into a range of grayscale values corresponding 0 to 255. However, the range of grayscale values to be converted is not necessarily limited to the range of grayscale values corresponding to 0 to 225, and may be converted into a narrower range of grayscale values.

As described above, if various correspondences according to the feature quantity are obtained, the correction table is generated on the basis of the correspondences.

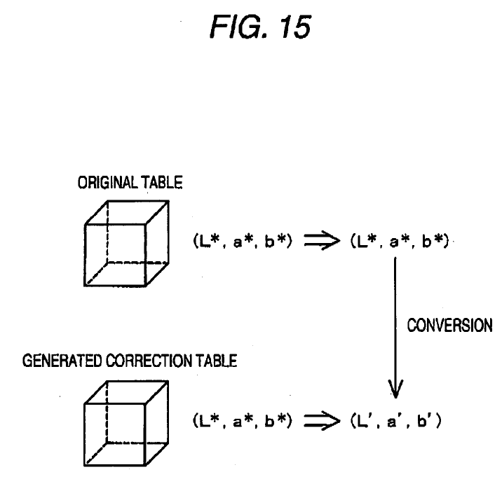

FIG. 15 conceptually shows how to generate a correction table based on the correspondence obtained in accordance with the feature quantity. When the correction table is generated, a table is prepared in which coordinate values of lattice points are set to the lattice points provided in a calorimetric color space. In this case, since the coordinate values are defined in the calorimetric color space, they become coordinate values that are represented by a combination of three colorimetric values of L*, a*, and b*. Next, after reading a coordinate value set to each lattice point, a coordinate value at each lattice point is converted according to a correspondence that is calculated according to a feature quantity. At this time, when a plurality of correspondences are calculated according to a plurality of feature quantities, a conversion is performed on each correspondence. In addition, a finally obtained coordinate value is stored at an original lattice point. FIG. 15 shows a state where coordinate values (L*, a*, and b*) set to lattice points are converted into values after correction (L′, a′, and b′), and are stored at original lattice points. This operation is performed on all of the lattice points, which generates a correction table. In step 204 of FIG. 11, as described above, a processing is performed for generating a correction table according to a feature quantity extracted from image data.

Then, the control circuit 260 corrects image data by referring to a correction table obtained in the above-described processing (step S206). Similar to the case where the color conversion is performed by referring to the color conversion table shown in FIG. 8, even in step S206, it is possible to quickly correct the image data by referring to the correction table.

As such, if the image data is corrected, finally, the image data in the colorimetric color space is converted into image data in an RGB color space (step S208). This conversion is a mere inverse conversion of a processing for converting an RGB color space into a calorimetric color space having been performed in step S200. Therefore, the conversion can be easily performed. When the image data returns to the image of the RGB color space, the image data correction shown in FIG. 11 is completed, and the processing returns to the image print processing of FIG. 7.

As described above, in the image data correction according to this embodiment, the image data is once converted into the image data of the calorimetric color space and the feature quantity is then extracted to correct the image data. Accordingly, since the feature quantity can always be obtained in the calorimetric color space, it is possible to correct the image data regardless of the color space where the image data is described.

Further, when the image data is corrected, the correction table is generated according to the extracted feature quantity. Although the processing for generating the correction table is necessary, after the correction table is once generated, it is possible to quickly correct the image data by referring to the correction table.

In addition, the correction table that is used in the image data correction according to this embodiment is different from a static table to be stored in advance, and is a table that is dynamically generated according to the image data. For this reason, an optimal correction table can be generated according to the image data, so that a high-quality image can be generated.

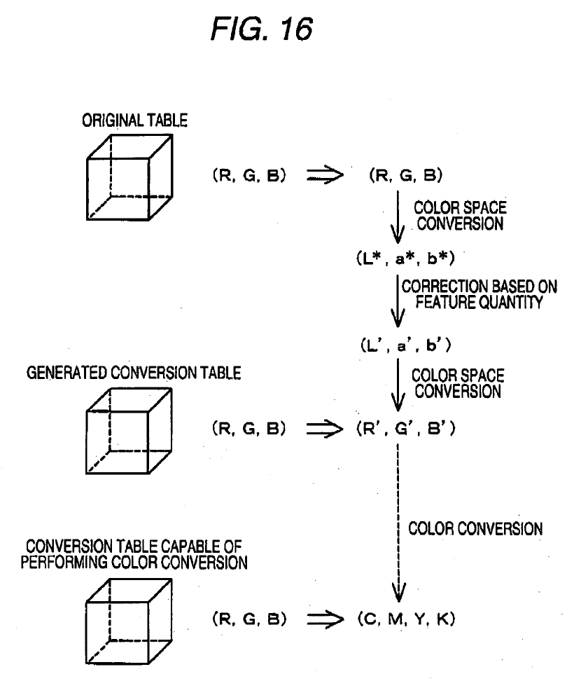

In this embodiment, the received image data is converted into the image data of the colorimetric color space of the received image data, the correction is performed by referring to the correction table, and the data after correction is converted into RGB image data again. That is, the image data is converted three times. However, an appropriate correction table in which a single conversion is performed may be generated. Hereinafter, such a modified example will be described with reference to FIG. 16.

In this case, since the image data to be printed is the RGB image data, first, a table is prepared in which coordinate values of lattice points are set to the lattice point provided in the RGB color space. In this case, since the coordinate values are defined in the RGB color space, they are coordinate values that are represented by a combination of three colors including R, G, and B.

Next, after reading the coordinate values of the RGB color space that are set to the lattice points, the color space is converted into the calorimetric color space. Then, the conversion is carried out in the same manner as in the above-described processing. In this case, a so-called L*a*b* color space is used as the calorimetric color space, the coordinate values (R, G, and B) at the lattice points are converted into the coordinate values (L*, a*, and b*) in the L*a*b* color space. Similar to the above-described embodiment, correction according to the feature quantity is performed on the coordinate values (L*, a*, and be) that are obtained in the above-described manner, and the coordinate values (L*, a*, and b*) are converted into the coordinate values (L′, a′, and b′) after correction. Then, inverse conversion is performed on a color space so as to be converted into the RGB color space from the L*a*b* color space, thereby obtaining the coordinate values (R′, G′, and B′) in the RGB color space. Then, the obtained coordinate values (R′, G′, and B′) are stored at the lattice points. When this operation is performed on the coordinate values at all of the lattice points, after the RGB color space is converted into the calorimetric color space, the correction is made in the calorimetric color space, and it is possible to generate a correction table in which a processing that performs inverse conversion on the color space so as to be converted into the RGB color space from the calorimetric color space can be performed by one-time conversion.

Alternatively, it is possible to a correction table where not only the above-described conversion of three times but also conversion of four times including a color conversion from the RGB image data to the CMYK image data can be performed by a single conversion. When the correction table is generated, after the image data is corrected according to the feature quantity, a color conversion is performed on the coordinate values (R′, G′, and B′) that are obtained by converting the color space from the colorimetric color space to the RGB color space so as to calculate a combination (C, M, Y, and K) of the grayscale values of the respective colors including C, M, Y, and K, and the combination of the grayscale values to be obtained is stored at the lattice point. The arrow of the dashed line shown in FIG. 16 conceptually indicates a state that a color conversion is performed on the coordinate values (R′, G′, and B′) after correction so as to calculate a combination (C, M, Y, and K) of grayscale values of the respective colors including C, M, Y, and K, and the obtained value is stored at a lattice point.

When referring to the correction table according to the modification that is obtained in the above-described processing, a correction processing according to a feature quantity in the colorimetric color space is performed on the RGB image data, the processing for converting the corrected data into the RGB image data (further, color conversion) can be performed with a single conversion performed by referring to the correction table. For this reason, the image data can be quickly corrected, which quickly outputs the image. Even in the modified example, the correction table is not a static table to be stored in advance, but a table that is dynamically generated according to the image data, it is possible to perform a proper correction. As a result, it is possible to generate a high-quality image.

Until now, the printing apparatus according to the embodiments has been described, but the invention is not limited to the above-described embodiments. That is, various modifications and changes can be made without departing from the spirit and scope of the invention.

For example, in the above-described embodiments, the case where the printing apparatus receives the image data and prints the image has been described. The way of generating an image is not limited to the printing. For example, the image may be generated on a display medium, such as a liquid crystal screen.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

The disclosure of Japanese Patent Application No. 2006-39299 filed Feb. 16, 2006 including specification, drawings and claims is incorporated herein by reference in its entirety.

What is claimed is:

1. A method of processing image data, comprising:
receiving first image data described on the basis of a first color space;
acquiring color space converting information adapted to be used to convert the first image data into second image data described on the basis of a prescribed second color space;
converting the first image data into the second image data in accordance with the color space converting information;
extracting a feature quantity from the second image data;
generating a correction table based on the feature quantity so as to include a correspondence between the second image data and third image data;
correcting the second data with reference to the correction table to generate the third image data; and
converting the third image data into fourth image data described on the basis of a third color space adapted to be used to generate an image.

2. The method as set forth in claim 1, wherein:
the second color space is a colorimetric color space.

3. The method as set forth in claim 1, further comprising:
generating the image based on the fourth image data.

4. A method of processing image data, comprising:
receiving first image data described on the basis of a first color space;
acquiring color space converting information adapted to be used to convert the first image data into second image data described on the basis of a prescribed second color space;
converting the first image data into the second image data in accordance with the color space converting information;
extracting a feature quantity from the second image data;
correcting the second image data based on the feature quantity to generate third image data;
converting the third image data into fourth image data described on the basis of a third color space adapted to be used to generate an image;
generating a conversion table based on the second image data and the third image data so as to include a correspondence between the first image data and the fourth image data; and
converting the first image data into the fourth image data with reference to the conversion table.

5. The method as set forth in claim 4, wherein:
the second color space is a calorimetric color space.

6. The method as set forth in claim 1, further comprising:
generating the image based on the fourth image data.

7. An apparatus operable to process image data, comprising:
a receiver, operable to receive first image data described on the basis of a first color space;
an acquirer, operable to acquire color space converting information adapted to be used to convert the first image data into second image data described on the basis of a prescribed second color space;
a first converter, operable to convert the first image data into the second image data in accordance with the color space converting information;
an analyzer, operable to extract a feature quantity from the second image data;
a table generator, operable to generate a correction table based on the feature quantity so as to include a correspondence between the second image data and third image data;
a corrector, operable to correct the second data with reference to the correction table to generate the third image data; and
a second converter, operable to convert the third image data into fourth image data described on the basis of a third color space adapted to be used to generate an image.

8. The apparatus as set forth in claim 7, wherein:
the second color space is a colorimetric color space.

9. The apparatus as set forth in claim 7, further comprising:
an image generator, operable to generate the image based on the fourth image data.

10. An apparatus operable to process image data, comprising:
a receiver, operable to receive first image data described on the basis of a first color space;
an acquirer, operable to acquire color space converting information adapted to be used to convert the first image data into second image data described on the basis of a prescribed second color space;
a first converter, operable to convert the first image data into the second image data in accordance with the color space converting information;
an analyzer, operable to enact a feature quantity from the second image data;
a first corrector, operable to correct the second image data based on the feature quantity to generate third image data;
a second converter, operable to convert the third image data into fourth image data described on the basis of a third color space adapted to be used to generate an image;
a table generator, operable to generate a conversion table based on the second data and the third data so as to include a correspondence between the first image data and the fourth image data; and
a third converter, operable to convert the first data with reference to the conversion table to generate the fourth image data.

11. The apparatus as set forth in claim 10, wherein:
the second color space is a calorimetric color space.

12. The apparatus as set forth in claim 10, further comprising:
an image generator, operable to generate the image based on the fourth image data.
